(19) United States
(12) Patent Application Publication
(10) Pub. No.: US 2017/0146395 A1
(43) Pub. Date: May 25, 2017

(54) CEILING-EMBEDDED SENSOR

(71) Applicant: IR-TEC INTERNATIONAL LTD., Taoyuan City (TW)

(72) Inventor: Wen-I Huang, Taoyuan City (TW)

(21) Appl. No.: 15/348,804

(22) Filed: Nov. 10, 2016

(30) Foreign Application Priority Data
Nov. 19, 2015 (TW) 104218551

(51) Int. Cl. G01J 1/02; G01J 1/44; H01H 13/14; G01J 1/42

(52) U.S. Cl. CPC G01J 1/0219; G01J 1/0271; G01J 1/029; G01J 1/4204; G01J 1/4228; G01J 1/44; H01H 13/14

(57) ABSTRACT

A ceiling-embedded sensor has a shell, a microprocessor inside the shell and electrically connected to an environmental light source sensor, an infrared sensing module, and a switch module. The microprocessor determines whether to activate the infrared sensor based on a detection result of the environmental light source sensor, thereby generating and outputting a trigger signal. The switch module is disposed on a reachable surface of a wall and near the infrared sensing module, and is used to turn on and off of the microprocessor and the power. The ceiling-embedded sensor is time-saving and convenient for shortly granting passage.

### BACKGROUND OF THE INVENTION

1. Field of the Invention

The invention relates to a sensor and, in particular, to a ceiling-embedded sensor disposed on a ceiling and with a reachable switch module.

2. Description of Related Art

With rising environmental awareness for power saving and carbon reduction, smart energy-saving has become an important trend to automatically control the operations of lighting or air conditioning in a specific area according to settings or environmental conditions for home or public spaces. For most space, it is doubtless that lighting and air conditioning are the two most important energy-consuming devices, and are also most likely to cause waste of energy, especially in public spaces. Since most public space users do not turn off lighting or air conditioning when it is no longer needed, a huge amount of energy is wasted. Therefore, ceiling-embedded sensors are developed to help with management of public spaces. According to environmental conditions and settings, they automatically turn on and off the lighting and air conditioning, in order to achieve the goal of energy saving and carbon reduction.

Existing ceiling-embedded sensors have the advantage of having fewer dead angles. Since they are more distant from the ground, it is cumbersome to find its power switch for power off when one needs to temporarily open a gate or for some other purposes. In such a case, one may also turn off devices that should be running. If the power switch controlling the ceiling-embedded sensor is not independent of other electrical equipment circuits, it will also affect other electrical equipment, causing inconvenience in usage. Therefore, it is desirable to further improve the power control of such ceiling-embedded sensors.

### SUMMARY OF THE INVENTION

In view of the foregoing, an objective of the invention is to provide a ceiling-embedded sensor that has an external physical switch disposed at a reachable place and near the ceiling-embedded sensor. The user can use the switch to control the electrical connection between the ceiling-embedded sensor and a power. This is convenient for the purpose of temporarily granting the passage.

To achieve the above-mentioned objective, the invention includes:

a shell whose surface has a cover;

a control module disposed inside the shell and including a microprocessor that has an environmental light source signal terminal, an infrared signal terminal, and a control terminal;

an environmental light source sensor disposed inside the shell and on the inner side of the cover and electrically connected with the environmental light source signal terminal of the microprocessor;

an infrared sensing module disposed inside the shell and on the inner side of the cover and electrically connected with the infrared signal terminal of the microprocessor;

a switch module disposed inside the shell and electrically connected with the control terminal of the microprocessor; and

a physical switch electrically connected with the switch module for controlling the microprocessor to temporarily disable the ceiling-embedded sensor via the switch module.

The physical switch connects to the switch module inside the shell via a wire, thereby controlling the electrical connection between the microprocessor and the power. The physical switch may be disposed near the shell at a place reachable by the user. The user can manually and easily control the microprocessor to temporarily disable the ceiling-embedded sensor for granting the passage. This is very convenient to temporarily stop the operation of the sensor.

### BRIEF DESCRIPTION OF THE DRAWINGS

FIG. 1 is an exploded view of the shell of the ceiling-embedded sensor;

FIG. 2 is a planar side view of the ceiling-embedded sensor;

FIG. 3 is a circuit block diagram of the ceiling-embedded sensor;

FIGS. 4A to 4D are circuit diagrams of the ceiling-embedded sensor; and

FIG. 5 is a schematic view of using the ceiling-embedded sensor.

### DETAILED DESCRIPTION OF THE PREFERRED EMBODIMENT

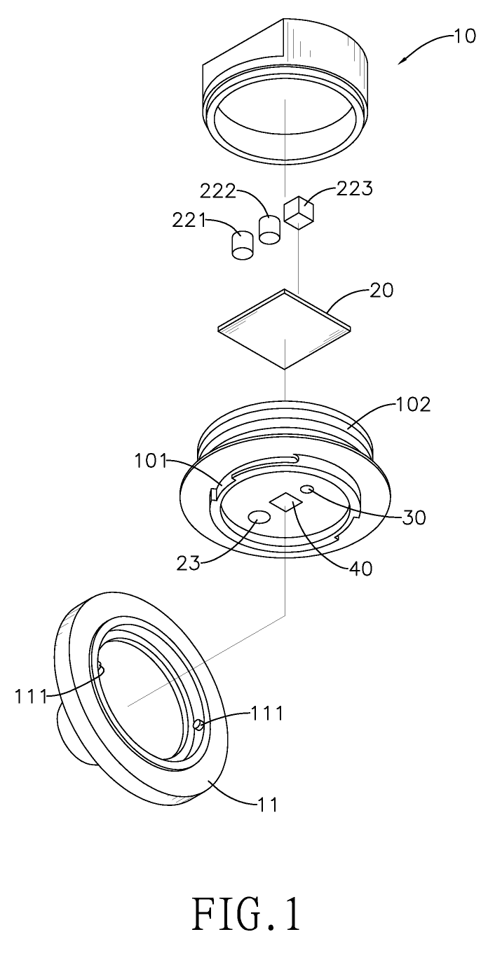

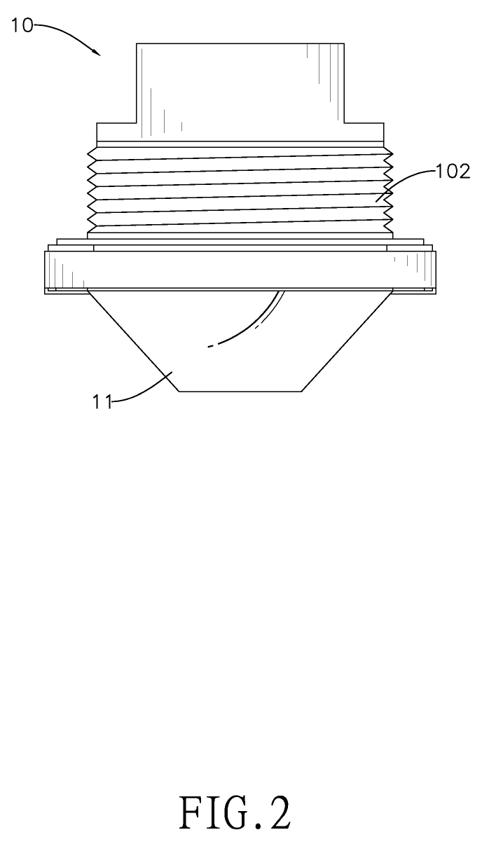

With reference to FIGS. 1 to 3, an embodiment of a ceiling-embedded sensor comprises a shell 10 accommodating a control module 20, an environmental light source sensor 30, an infrared sensing module 40, a switch module 50, and a physical switch 60 independently disposed outside the shell 10.

The shell 10 is engaged with a cover 11. In this embodiment, the cover 11 is made of a material that allows visible light and infrared light to penetrate through. The cover 11 covers the environmental light source sensor 30 and the infrared sensing module 40 mounted in the shell 10. The cover 11 has an opening with a rim on which two protruding blocks 111 are disposed toward inside. The protruding blocks 111 each engage a respective annular groove 101 formed on the shell 10. On the opposite side of the cover 11, the outer surface of the shell 10 is formed with a thread 102 to be screwed onto the ceiling.

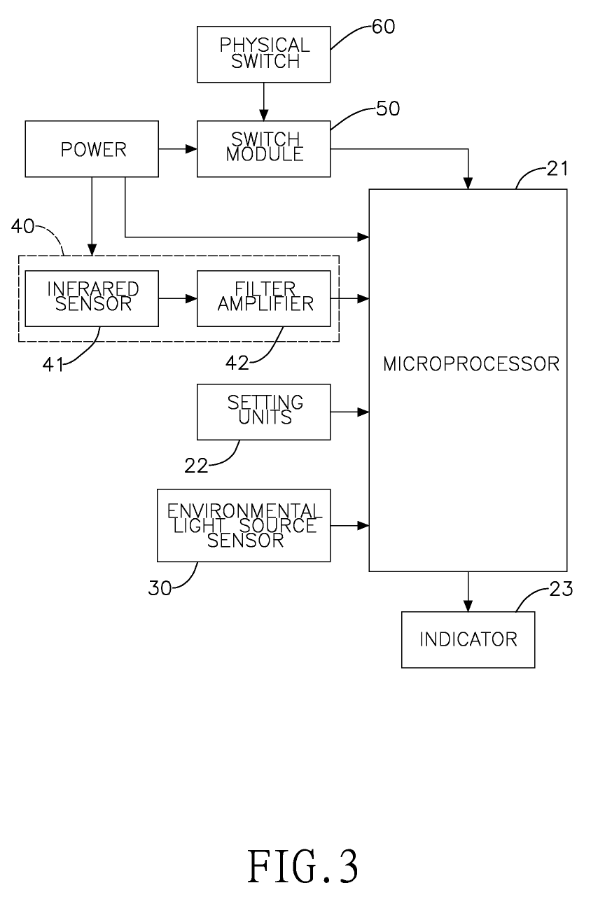

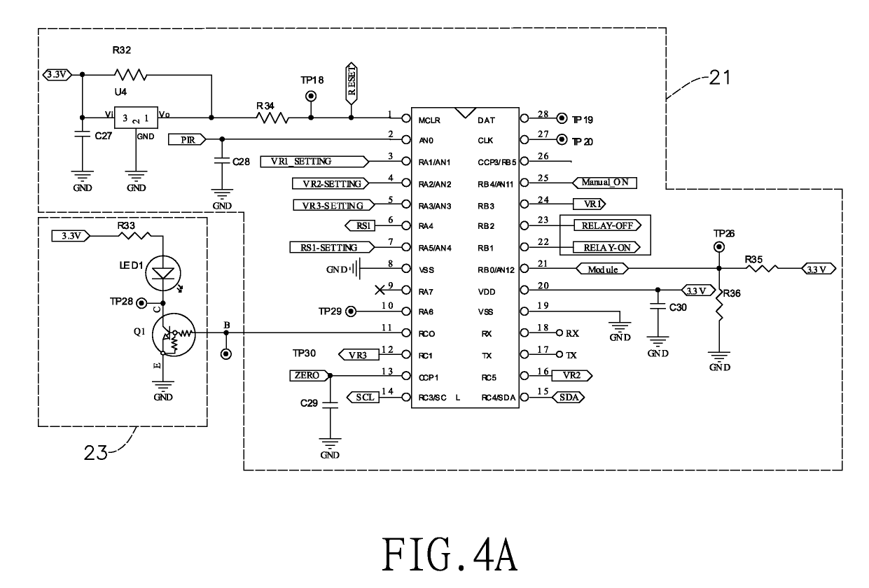

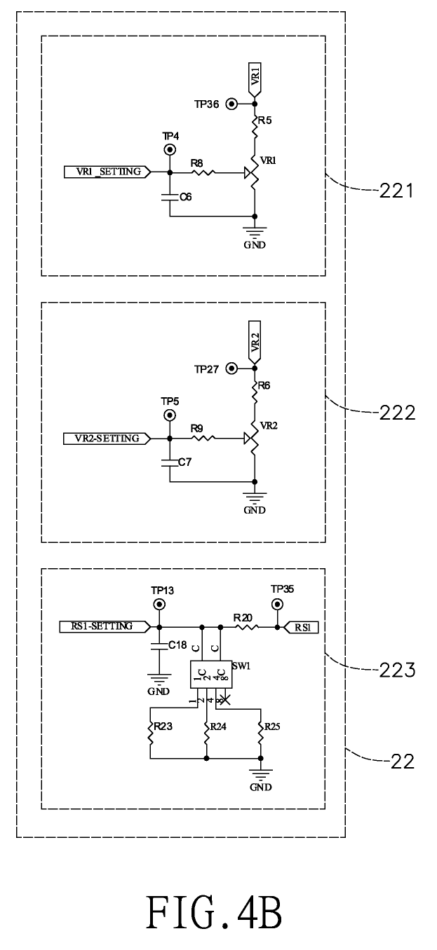

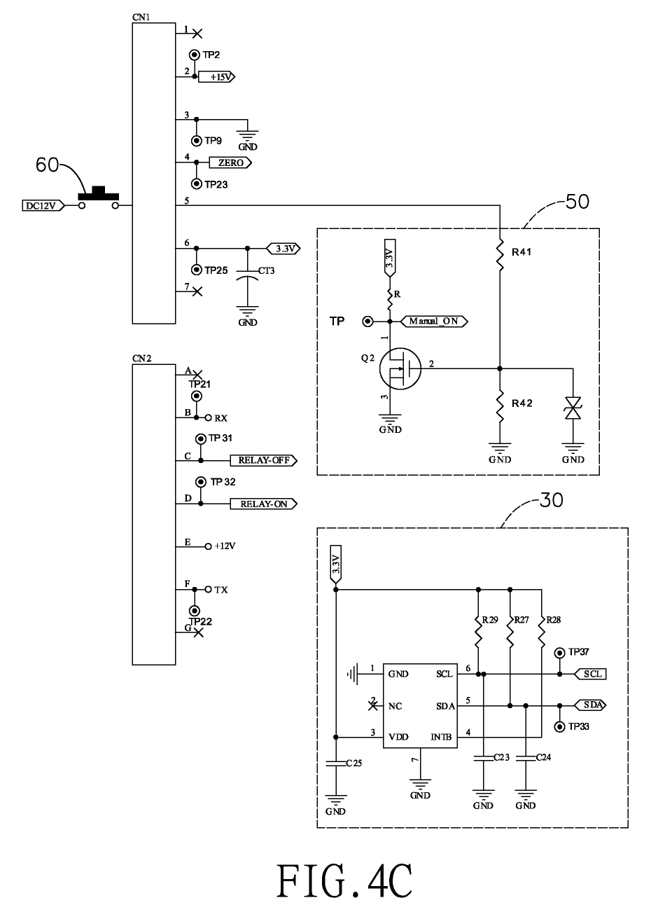

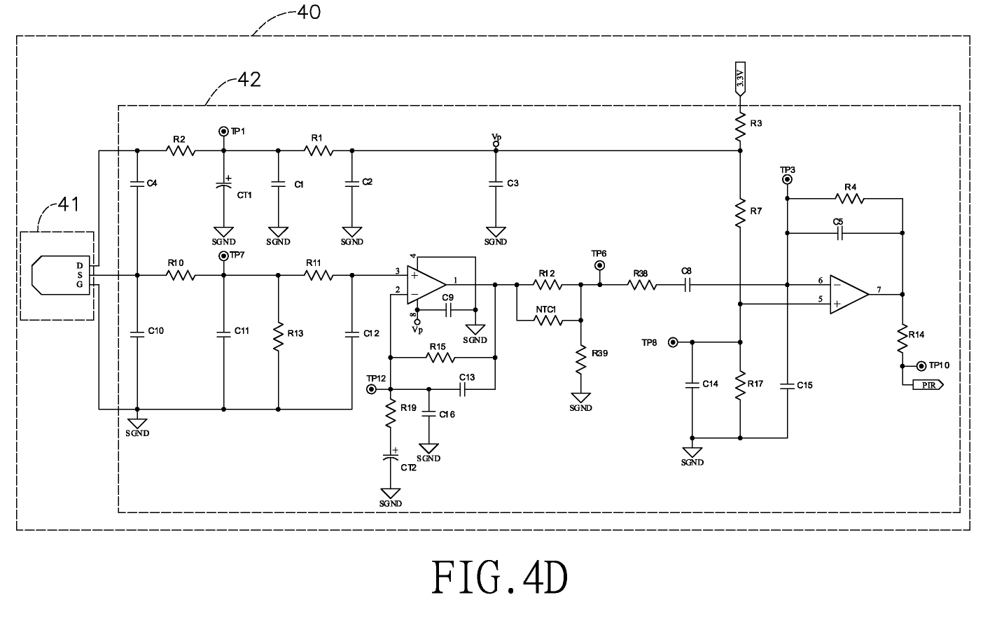

With reference to FIGS. 3, 4A and 4B, the control module 20 includes a microprocessor 21, a plurality of setting units 22, and an indicator 23. The microprocessor 21 has two environmental light source signal terminals RC3/SCL, RC4/SDA, an infrared signal terminal AN0, and a control terminal RB4/AN11. The two environmental light source signal terminals RC3/SCL, RC4/SDA electrically connect to the environmental light source sensor 30. The infrared signal terminal AN0 electrically connects to the infrared sensing module 40. The control terminal RB4/AN11 electrically connects to the switch module 50. The microprocessor 21 further electrically connects to the plurality of setting units 22 and the indicator 23. In this embodiment, the indicator 23 is a light-emitting diode (LED) disposed on the inner side of the cover 11 and flashes to show the status of the infrared sensing module 40.

With further reference to FIG. 4C, the environmental light source sensor 30 is disposed inside the shell 11 corresponding to an inner side of the cover 11 and detects the luminance of the background light source in the environment. According to the detection result of the environmental light source sensor 30, the microprocessor 21 determines whether to activate the infrared sensing module 40 and to generate and output a trigger signal. In this embodiment, the trigger signal lights up an illuminating device.

One end of the physical switch 60 electrically connects to the switch module 50 to control the microprocessor 21 via the switch module 50. In this embodiment, the switch module 50 has a metal oxide semiconductor field effect transistor (MOSFET) Q2. A gate of the MOSFET Q2 electrically connects to one end of the physical switch 60 via a first dividing resistor R41 and to a ground via a second dividing resistor R42. A drain of the MOSFET Q2 electrically connects to the power control terminal RB4/AN11 of the microprocessor 21. A source of the MOSFET Q2 electrically connects to the ground. The other end of the physical switch 60 electrically connects to an external DC power DC12V.

When the user presses the physical switch 60, the power provided by the external DC power DC12V is transmitted via the conductive physical switch 60 to the first dividing resistor R41. Through the first dividing resistor R41 and the second dividing resistor R42, the gate of the MOSFET Q2 is powered so that the MOSFET Q2 becomes conductive, making the control terminal RB4/AN11 of the microprocessor 21 connect to the ground. The microprocessor 21 temporarily disables sensing function, thus temporarily granting the passage of the space. This is particularly convenient for temporarily stopping the operation of the ceiling-embedded sensor. When the physical switch 60 is pressed again, the microprocessor 21 will enable the sensing function.

As shown in FIG. 4B, the plurality of setting units 22 in this embodiment comprise a first setting unit 221, a second setting unit 222, and a switching unit 223.

The first setting unit 221 includes a first variable resistor VR1. The first variable resistor VR1 electrically connects to a first resistor R5 and a first voltage setting port VR1_SETTING of the microprocessor 21. The first variable resistor VR1 adjusts its resistance and, according to the voltage divider rule, changes a voltage supplied to the first voltage setting port VR1_SETTING of the microprocessor 21. The first voltage setting port VR1_SETTING is used to set the sensitivity of the environmental light source sensor 30 to the environmental luminance.

The second setting unit 222 includes a second variable resistor VR2. The second variable resistor VR2 electrically connects to a second resistor R6 and a second voltage setting port VR2-SETTING of the microprocessor 21. The second variable resistor VR2 adjusts its resistance and, according to the voltage divider rule, changes the voltage output to the second voltage setting port VR2-SETTING The second voltage setting port VR2-SETTING sets a delay off time of the trigger signal.

The switching unit 223 includes a third resistor R20, a switch SW1 electrically connected to the third resistor R20, and three dividing resistors R23, R24, R25. Dividing nodes are connected to the microprocessor 21. The switch SW1 is used to set the serial/parallel connection relation between the three dividing resistors R23, R24, R25 and the resistor R20. At the same time, it changes the voltage at the corresponding port of the microprocessor 21, thereby switching among different task modes.

The infrared sensing module 40 is disposed inside the shell 10 and on the inner side of the cover 11. The infrared sensing module 40 includes an infrared sensor 41 and a filter amplifier 42. With reference to FIG. 4D, the filter amplifier 42 electrically connects to the infrared sensor 41 and the infrared signal terminal of the microprocessor 21. The infrared sensor 41 is used to detect the infrared light emanated from human bodies in the environment, thereby determining whether any human body is present. In this embodiment, the infrared sensor 41 is a passive infrared (PIR) sensor.

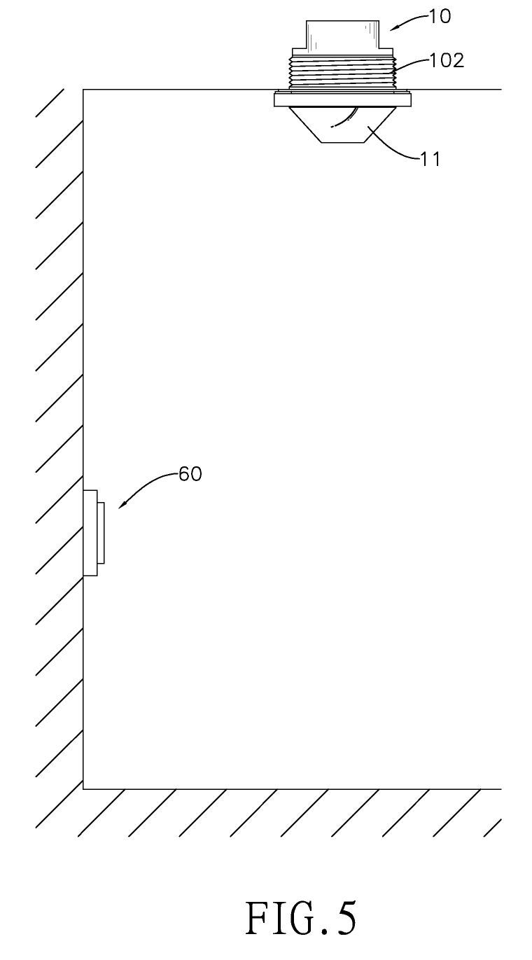

With reference to FIGS. 4C and 5, the physical switch 60 in this embodiment is disposed on a reachable position on the wall near the shell 10. The user can manually enable and disable the ceiling-embedded sensor by the physical switch 60.

The ceiling-embedded sensor makes use a physical switch 60 that can remotely control the microprocessor 21. The physical switch 60 is disposed at a reachable place near the shell 10. The user does not need to look for a distant local power control box. No other electronic devices are affected when the disclosed sensor temporarily grants the passage of space under monitor. The invention is thus very convenient for temporarily disabling the sensor.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A ceiling-embedded sensor comprising:
a shell engaged with a cover;
a control module disposed inside the shell and comprising a microprocessor that has an environmental light source signal terminal, an infrared signal terminal, and a control terminal;
an environmental light source sensor disposed inside the shell and on an inner side of the cover and electrically connected to the environmental light source signal terminal of the microprocessor;
an infrared sensing module disposed inside the shell and on the inner side of the cover and electrically connected to the infrared signal terminal of the microprocessor;
a switch module disposed inside the shell and electrically connected to the control terminal of the microprocessor; and
a physical switch electrically connected to the switch module to control the microprocessor via the switch module for disabling and enabling a sensing function of the microprocessor.

2. The ceiling-embedded sensor as claimed in claim 1, wherein the infrared sensing module includes an infrared sensor and a filter amplifier, and the filter amplifier is electrically connected to the infrared sensor and the infrared signal terminal of the control module.

3. The ceiling-embedded sensor as claimed in claim 2, wherein the control module further includes a plurality of setting units each of which electrically connects to the microprocessor.

4. The ceiling-embedded sensor as claimed in claim 3, wherein at least one of the setting units includes a variable resistor electrically connected to a resistor and a voltage setting port of the microprocessor.

5. The ceiling-embedded sensor as claimed in claim 3, wherein one of the setting units is a switching unit that includes a resistor, a load switch electrically connected to the resistor of the switching unit, and three dividing resistors, wherein each of the dividing resistors is connected to the resistor of the switching unit via the load switch.

6. The ceiling-embedded sensor as claimed in claim 1, wherein the control module further includes an indicator disposed inside the cover and electrically connected to the microprocessor.

7. The ceiling-embedded sensor as claimed in claim 6, wherein the indicator is a light-emitting diode.

8. The ceiling-embedded sensor as claimed in claim 7, wherein the shell has an outer surface formed with two annular grooves, and the outer surface of the shell opposite to the cover is formed with a thread.

9. The ceiling-embedded sensor as claimed in claim 8, wherein a rim of an opening of the cover is disposed with two protruding blocks toward the inside for engaging the two annular grooves of the shell.

10. The ceiling-embedded sensor as claimed in claim 1, wherein the switch module includes:
a first dividing resistor;
a second dividing resistor;
a metal oxide semiconductor field effect transistor (MOSFET) having a gate, a drain, and a source, with the gate electrically connecting to a first end of the physical switch via the first dividing resistor, the gate electrically connecting to the ground via the second dividing resistor, the drain electrically connecting to the control terminal of the microprocessor, the source electrically connecting to the ground;
wherein a second end of the physical switch electrically connects to an external direct-current power.
